(19) United States
(12) Patent Application Publication
(10) Pub. No.: US 2014/0042766 A1
(43) Pub. Date: Feb. 13, 2014

(54) Vehicle Security System For Secondary Storage Compartments

(71) Applicant: Cory L. Meyer, Tomball, TX (US)

(72) Inventor: Cory L. Meyer, Tomball, TX (US)

(21) Appl. No.: 13/569,805

(22) Filed: Aug. 8, 2012

(51) Int. Cl. B60R 7/04

(52) U.S. Cl. 296/37.8; 296/37.1

(57) ABSTRACT

A vehicle having a secondary storage compartment which is reinforced, and is independently controllable by a remote actuator which will secure the compartment simultaneously with primary locks, and will allow unlocking either simultaneously with primary locks, or independently of primary door locks.

### BACKGROUND OF THE INVENTION

Vehicle break-ins occur all over the world. Most smash-and-grab thieves act on impulse. If valuables are visible they are a target for theft. But thieves also know that valuables are often stowed away in unlocked and easily opened storage compartments. Few people will take the time to lock glove boxes, center consoles, or other secondary storage compartments. Locking them takes time, and unlocking them later is inconvenient, especially if the key to do so is the same one that is already in the ignition of a running vehicle.

To lock secondary compartments one usually has to utilize a key. These compartments are often constructed of plastic or other materials easily bent or broken. They are not configured as secure areas. Thieves observe mounting brackets, chargers, or other accessories which are indicative of valuable electronics likely to be found in the unsecure interior compartments once entry is gained to a vehicle. A more secure method of storing items in a vehicle is needed, and that method must not be inconvenient to the vehicle's user, or it will be unutilized.

### BRIEF DESCRIPTION OF THE DRAWINGS

FIG. 1 illustrates a diagram of a vehicle security system in accordance with an exemplary embodiment of the invention.

FIG. 2 illustrates a signal sequence of a multi-state vehicle security system in accordance with an exemplary embodiment of the invention.

FIG. 3 illustrates an alternative signal sequence of a multi-state vehicle security system in accordance with an exemplary embodiment of the invention.

### DETAILED DESCRIPTION OF THE PREFERRED EMBODIMENTS

Described herein is a way of securing valuables in a vehicle by making the securing of secondary compartments more convenient to the vehicle operator and therefore increasing the probability of use. Most vehicles on the road today have secondary storage compartments. Examples include, but are not limited to, glove compartments, center consoles, floor board compartments, external tool chest, tailgate boxes, wheel well storage boxes.

By utilizing electronic locks on secondary storage components, it becomes easier for the vehicle operator to lock the secondary storage components when locking the primary locks of the vehicle. In one embodiment of the system utilizes a multi-state communication system to lock and unlock storage compartments as an extension of the rest of the vehicle and the normal functions of a standard electronic lock system. In such a system, a remote controller is programmed such that pressing the lock button will lock the primary locks on the entry/exit doors of the vehicle, and the secondary locks on the storage compartments. The concept being that if any entry point needs to be secured, then it is more beneficial to secure every entry point. On such a system the multiple states would allow a user to unlock a single primary lock (e.g. a driver's door), all primary locks, or all primary and secondary locks.

One embodiment of the multi-state system may utilize a series of signals within a predetermined time period to determine which locks are activated/deactivated. In one embodiment the system comprises a timer which is activated for a designated period of time upon a first input signal. Expiration of the designated period of time will cause the system to reset to an initial state. Successive input signals will reset the period of time, but progress the system to a successive state. In such a system, a first pulsing of the unlock signal may cause the system to disable an alarm system. A second pulse may cause the system to unlock primary locks, and a third pulse may cause the system to unlock secondary locks.

It is of little value to have a lock on a compartment which is easily entered by other means. For instance, in some vehicles, a glove compartment may not have a lock, but simply a latching mechanism. Some glove compartments are accessible by reaching up behind the compartment from under the dashboard. In other vehicles, a center console may latch and lock, but the lid is secured with only a couple of screws driven into a plastic casing. For the vehicle's secondary compartments to have increased theft deterrence, in addition to locks which are utilized on a regular basis, the secondary compartments must also be reinforced in some manner.

In one embodiment , the plastics or composite materials utilized in manufacturing the compartments may be impregnated with fibers, which prevent cracking or breaking the compartment. In another embodiment, the compartments may be manufactured from or lined with a more structurally sufficient material such as aluminum or steel.

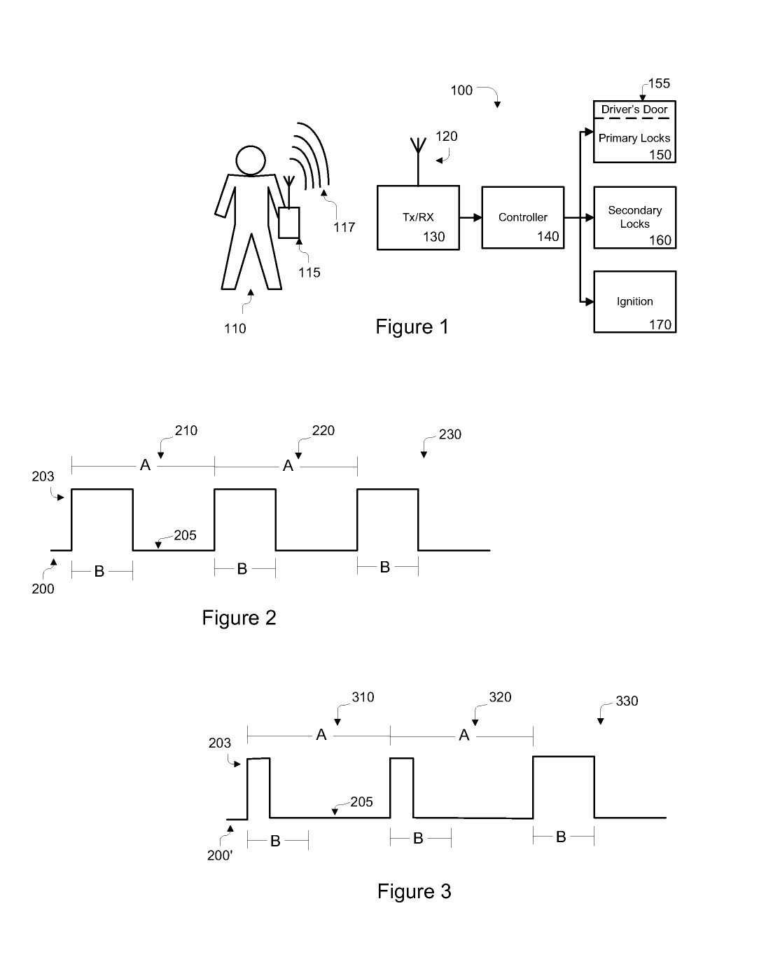

FIG. 1 illustrates a diagram of a vehicle security system in accordance with an exemplary embodiment of the invention. The vehicle locking system (100) may be controlled by a remote (115) which emits a signal (117) when the user (110) operates one or more controls on the remote (115). The signals are detected by a transmit and receive (Tx/Rx) component (130) with a detection device (120) such as an antenna. The Tx/Rx (130) component utilizes a controller (140) which is programmed to operate a plurality of vehicle sub-systems based on a predetermined activity sequence. In one embodiment, a signal may cause the primary locks (150) of the vehicle to lock, the secondary locks (160) of the secondary storage compartments to lock, and the ignition (170) to disable. In another embodiment, a signal may cause only the driver's door (155), one of the primary locks (150) to unlock, and the ignition (170) to enable. A second signal may cause the rest of the primary locks (150) and the secondary locks (160) to unlock. In another embodiment, the controller (140) may be programmable by the user (110) to have a unique function, or series of functions, depending on the signals received to suit the user's (110) needs and habits. One skilled in the art would appreciate that radio transmissions may utilize an antenna but other remote communications may utilize different transmit and receive devices which would be analogous.

FIG. 2 illustrates a signal sequence of a multi-state vehicle security system in accordance with an exemplary embodiment of the invention. The signal (200) is comprised of a plurality of units which transition between a first state (205) and a second state (203) during a pre-determined time period (A). A secondary time period (B) which is shorter than the first time period (A) is used to determine if the signal activates a controller change.

In the illustrated signal (200), a first unit (210) comprises a transition to a first state (203) followed by a transition to a second state (205) at some point in time substantially equal to the secondary time period (B). Such transition within the time periods indicates to the controller of the vehicle to take a first action, such as, but not limited to, unlocking a driver's door. A second unit (220) of similar composition indicates to the controller of the vehicle to take a second action, such as, but not limited to, unlocking all primary locks. A third unit (230) of similar composition indicates to the controller of the vehicle to take a second action, such as, but not limited to, unlocking all secondary locks.

With such a signal, a user may selectively open only a single door, all doors, or all doors and storage compartments selectively by terminating the sequence at some point before sending all three units. In another embodiment, the sequence may be extended to allow additional units which cause the controller to take other actions.

FIG. 3 illustrates an alternative signal sequence of a multi-state vehicle security system in accordance with an exemplary embodiment of the invention. The signal (200′) is comprised of a plurality of units which transition between a first state (205) and a second state (203) during a pre-determined time period (A). A secondary time period (B) which is shorter than the first time period (A) is used to determine if the signal activates a controller change.

In the illustrated signal (200′), a first unit (310) comprises a transition to a first state (203) followed by a transition to a second state, (205) at some point in time substantially less than the secondary time period (B). Such transition within the time periods indicates to the controller of the vehicle to NOT take a first action. However such transition indicates to the controller that a second transition may follow and that subsequent actions are to be interpreted based on subsequent transitions. A second unit (320) of similar composition indicates to the controller of the vehicle to NOT take a second action. However such transition indicates to the controller that a third transition may follow and that subsequent actions are to be interpreted based on subsequent transitions. A third unit (330) comprises a transition to a first state (203) followed by a transition to a second state (205) at some point in time substantially equal to the secondary time period (B). Such transition within the time periods indicates to the controller of the vehicle to take a third action, such as, but not limited to, unlocking secondary locks. Utilization of such a system allows a user to selectively indicate to the controller of the vehicle to take some actions, but not others. One skilled in the art would appreciate that different combinations could be utilized by the user to accomplish multiple sequences of desired tasks.

The diagrams in accordance with exemplary embodiments of the present invention are provided as examples and should not be construed to limit other embodiments within the scope of the invention. For instance, the blocks should not be construed as individual steps or components that must be discreet or oriented relative to other components. Additional blocks/steps may be added, some blocks/steps removed, or the order of the blocks/steps altered and still be within the scope of the invention. Further, sequences of signals may vary, and the actions they indicate may vary. The relative state levels and timing relationships are not always indicative of a required implementation. Further, some state levels may actually represent multiple state levels, or may be inadvertently related to other state levels. Further yet, specific numerical data values (such as specific quantities, numbers, categories, etc.) or other specific information should be interpreted as illustrative for discussing exemplary embodiments. Such specific information is not provided to limit the invention.

The diagrams in accordance with exemplary embodiments of the present invention are provided as examples and should not be construed to limit other embodiments within the scope of the invention. For instance, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A vehicle comprising;
a primary compartment;
a plurality of secondary compartments;
said secondary compartments having locking mechanisms.

2. A vehicle, as described in claim 1, wherein said locking mechanisms are remotely operable.

3. A vehicle, as described in claim 2, wherein said plurality of locking mechanisms are singularly controllable.

4. A vehicle, as described in claim 2, wherein said remotely operable locks are controlled by wireless communications.

5. A vehicle, as described in claim 2, wherein said remotely operable locks are controlled by wired communications from a remote location on the vehicle.

6. A vehicle, as described in claim 4, wherein said remotely operable locks are separately controllable from other locks on the vehicle for purposes of unlocking said locks.

7. A vehicle, as described in claim 4, wherein said remotely operable locks are simultaneously operated with other locks on the vehicle for purposes of locking said locks.

8. A vehicle, as described in claim 4, wherein said remotely operable locks are programmable by a vehicle owner to be simultaneously or separately operable with other locks on the vehicle for purposes of locking and unlocking said locks.

9. A vehicle, as described in claim 1, wherein said secondary compartments are reinforced compartments.

10. A vehicle, as described in claim 9, wherein said reinforcement of secondary compartments is by use of fiber reinforced plastics for the construction of the compartment.

11. A vehicle, as described in claim 9, wherein said reinforcement of secondary compartments is by use of metal for the construction of the compartment.

12. A vehicle, as described in claim 11, wherein said metal construction is aluminum.

13. A vehicle, as described in claim 11, wherein said metal construction is steel.
